(19) United States
(12) Patent Application Publication
(10) Pub. No.: US 2021/0123753 A1
(43) Pub. Date: Apr. 29, 2021

(54) ENHANCED PATH MAPPING BASED ON SAFETY CONSIDERATION

(71) Applicant: INTERNATIONAL BUSINESS MACHINES CORPORATION, Armonk, NY (US)

(72) Inventors: Dong Hui Liu, Beijing (CN); Peng Hui Jiang, Beijing (CN); Yong Yin, Beijing (CN); Jia Yu, Beijing (CN); Jia Tian Zhong, Beijing (CN); Xing Xing Shen, Beijing (CN)

(21) Appl. No.: 16/662,450

(22) Filed: Oct. 24, 2019

(51) Int. Cl. G01C 21/34; G05D 1/00

(52) U.S. Cl. CPC G01C 21/3453; G01C 21/3415; G01C 21/3446; G05D 1/0088

(57) ABSTRACT

The present invention relates to a method for enhanced path mapping based on safety consideration. To provide a method to determine a superior path from at least two alternative paths, it is proposed that the navigation system adds one or more new safety parameters based on safety consideration in path mapping process and calculate a path safety index for the alternative paths. The safety parameters may include a biometric index of at least one of drivers of vehicles on the alternative paths, a physical status of the vehicles or environment, a driving habits index of at least one of drivers of the vehicles and/or an autonomous vehicle safety index of at least one of the vehicles.

### BACKGROUND

The present disclosure relates to intelligent navigation, and more specifically, to a computer program product, method and system for enhanced path mapping based on safety consideration.

Intelligent navigation applications allow a user to plan paths. Furthermore, the incorporation of GPS (Global Positioning System) units and intelligent navigation applications provide users turn by turn directions from such applications, e.g. when operating a moving vehicle, a flying plane or walking. Furthermore, Intelligent navigation applications have evolved to provide rudimentary or interesting information to users, such as traffic situation, weather conditions, tourist info etc.

### SUMMARY

The proposed disclosure has been made in an effort to enhance vehicle navigation by adding one or more new parameters based on safety consideration in navigational path mapping. The new parameters may be based on safety considerations for alternative paths that are provided by the navigation system, whereby the safety considerations may be based on a vehicle's operational status and a driver's biometric information.

According to one or more embodiments of the present disclosure, there is provided a method for enhanced path mapping based on safety considerations. To enhance the path mapping, a method comprises obtaining a path mapping inquiry to at least one expected destination. The method also comprises generating two or more alternative paths to the at least one expected destination. The method also comprises collecting vehicle parameters from one or more vehicles on the alternative paths, whereby the vehicles include man-driving vehicles or autonomous vehicles. The method also comprises processing the vehicle parameters to calculate path safety indexes of the alternative paths. The method also comprises determining a superior path in the alternative paths based on the path safety indexes.

According to one or more embodiments of the present disclosure, the method for enhanced path mapping based on safety consideration can also be implemented as a system and computer program product.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts an exemplary method a path determination process according to an embodiment of the present disclosure.

FIG. 2 depicts a process flow of an example operation according to an embodiment of the present disclosure.

FIG. 2A depicts factors of Environment Safety Index according to an embodiment of the present disclosure

FIG. 3 depicts an exemplary operation for splitting an alternative path into sections according to an embodiment of the present disclosure.

FIG. 4 depicts an operational flowchart of an example operation according to an embodiment of the present disclosure.

FIG. 5 depicts a navigation system according to an embodiment of the present disclosure.

FIG. 6 depicts another navigation system according to an embodiment of the present disclosure.

FIG. 7 depicts a cloud computing node according to an embodiment of the present disclosure.

FIG. 8 depicts a cloud computing environment according to an embodiment of the present disclosure.

FIG. 9 depicts model layers according to an embodiment of the present disclosure.

### DETAILED DESCRIPTION

Generally, navigation devices that include GPS signal reception and processing functionality are well known and are widely employed as in-vehicle or other vehicle navigation systems. In general, a modern navigation device comprises a processor, memory, and map data stored within the memory. The processor and memory cooperate to provide an environment in which a software operating system may be established, and additionally it is commonplace for one or more additional software programs to be provided to enable the functionality of the device to be controlled and to provide various other functions.

The rapid development of navigational systems and their miniaturization allow intelligent navigation systems to be incorporated into handheld devices such as mobile phones, PDAs etc. In some instances, intelligent navigation systems further include servers to store and process navigation data, and transmit navigation information to handheld, in-vehicle or other mobile navigation devices by networks, such as LAN, WAN, WLAN, WIFI, 3G, 4G etc. In some instances, the servers are medium-sized computers, mainframes, giant computers or Cloud Computers etc.

Several techniques for planning navigation paths exist which may comprise using the fastest, shortest, cheapest route for passing or avoiding specific points etc. For instance, when calculating the optimum path from starting point to terminal point, the travel cost for the different paths is calculated, and a decision is made upon value of the travel cost. One type of travel cost would be the distance between the two points, the speed limitation of the paths, or the actual speed of the vehicles on the paths at a certain time. A server using this travel cost would help to optimize the path based on different parameters, such as traffic congestion degree, etc.

Furthermore, an advanced driver assistance system (ADAS) that recognizes an accident risk in advance to prevent an accident or assist in driving may be actively mounted on a vehicle. The advanced driver assistance system (ADAS) may include a function to detect a driver's fatigue, and it is possible to provide appropriate driver assistance functions by considering the driver's degree of fatigue.

In some instances, the ADAS may also include a recording system that records a driver's driving habits, which could sense and record a driver's vehicle operational actions within a certain distance or time to analyze the driver's driving habits, such as turning, braking, throttling up/down the engine etc. The ADAS would provide driver assistance functions by considering the driver's driving habits to help the driver avoid faulty operations.

As previously described, one problem in driver assistance systems is that intelligent navigation applications do not consider safety factors in the environment, such as the driver's degree of fatigue or driving habits of drivers who are driving on the path, authoritative safety rating for vehicles on the paths, or the route safety index based on the weather, etc. Furthermore, advanced driver assistance systems (ADAS) focus on predicting individual driver's fatigue, and the impact that a driver's fatigue has on other drivers or other vehicles on the same route is not taken into account. For instance, it is necessary to consider the interaction between man-driving vehicles and autonomous vehicles in a mixed environment where the man-driving vehicles and the autonomous vehicles co-exist.

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

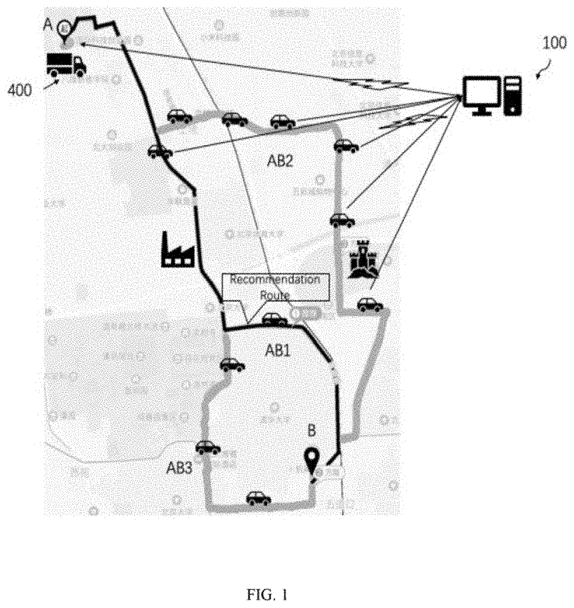

With reference now to FIG. 1, the present disclosure according to one exemplary embodiment is depicted in FIG. 1.

FIG. 1 depicts an exemplary method of a path determination according to the present disclosure.

A user of a vehicle 400, for instance, a driver of a man-driving vehicle or a passenger of an autonomous vehicle, plans to travel from starting point A to destination B. The user inputs an inquiry of the destination B into an intelligent navigation system 100 using an inputting device, for instance, an interactive interface device of a handheld device or an in-vehicle navigation device, such as a touch screen of a mobile phone, PDA or in-vehicle navigator device etc. In some instances, the destination B is a recommended place by the navigation system 100 based on the user's interest or travel requirements, such as Gas Stations, scenic spots, restaurants or hotels etc.

According to FIG. 1, there are, for instance, three alternative paths available and provided by the navigation system 100: AB1, AB2 and AB3. Some factors can be considered into generating the alternative paths. These factors include: the shortest distance from the starting point to destination, the minimal time on traveling from the starting point to the destination, traffic status of the whole path, tolls or expenses, the running speed which is higher on highways or the environment on the path etc.

In FIG. 1, the path AB1 is the shortest route in the three alternative paths. The path AB3 is also a short route and has a better traffic status on the path, therefore, the path AB3 has the minimal time from point A to point B. The path AB2 is a longer route but it bypasses some driver's and passenger's interested places, for instance, a university and/or scenic spot.

The navigation system 100 further collects a plurality of safety parameters from one or more vehicles which are running on the alternative paths using detecting devices. In one embodiment of the present disclosure, the vehicles on the alternative paths are man-driving vehicles, i.e. vehicles that may be operated/driven by a person. Also, according to one embodiment of the present disclosure, the vehicles on the alternative paths are autonomous vehicles, i.e. vehicles that may be machine operated or not driven by a person. In a further embodiment, the vehicles on the alternative paths are man-driving vehicles and autonomous vehicles.

The safety parameters include aspects associated with the safety of a vehicle. In one embodiment of the present disclosure, at least one of the safety parameters is related to a biometric index of drivers of the man-driving vehicles which indicate a degree of fatigue of the driver. In one embodiment of the present disclosure, the biometric index may be one or more directly measured values of physiological activities of a driver, such as eye-blink rate, blood pressure, heart rate, breathing frequency, electromyogram levels etc. In another embodiment of the present disclosure, the biometric index may be a conversional value based on one or more directly measured values of physiological activities.

In another embodiment of the present disclosure, at least one of the safety parameters is related to an operational status of the vehicles on the alternative paths. In some instances, the operational status indicates geographic position of the vehicles and/or dynamic statuses of the vehicles such as vehicle parts information and status of vehicle parts information.

In another embodiment of the present disclosure, at least one of the safety parameters is related to a physical status of environment. The physical status of environment may be temperature, weather or a road condition evaluation value to one of the alternative paths etc.

A path safety index of each of the alternative paths may be calculated by processing the safety parameters. According to the path safety index, for instance, the minimum (or maximum) path safety index in each of the alternative paths may be determined. In FIG. 1, the superior or optimal path as a recommended for the user of the navigation system 100, may be displayed on the screen of the handheld device or in-vehicle navigation device with a label “Recommendation Route”. As a result, the driver of the man-driving vehicle 400 chooses the superior path using the interactive interface device, then the navigation system 100 guides the driver to drive the vehicle 400 to the destination, for instance, through visual and/or voice commands.

In another embodiment of the present disclosure, the user of the autonomous vehicle 400 chooses the superior path, and the navigation system 100 navigates the autonomous vehicle 400 to the destination. It is recognized that the navigation system 100 may be integrated into the autonomous vehicle 400 as a part of an autonomous driving control system of the autonomous vehicle 400 so that the user of the autonomous vehicle 400 does not need to choose the superior path. Conversely, the autonomous driving control system chooses the superior path as a preset program or instruction.

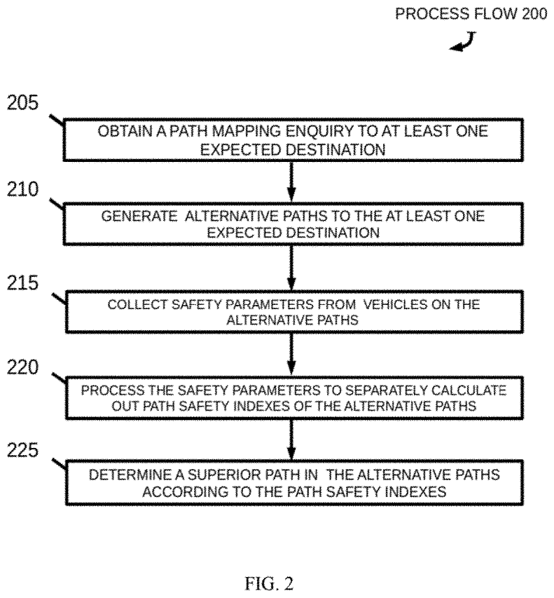

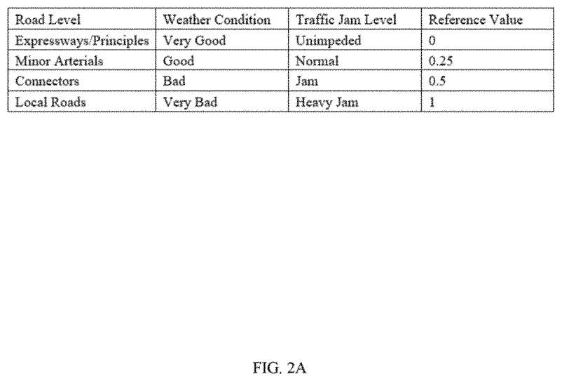

With reference now to FIG. 2, an example operation of the present disclosure according to one exemplary embodiment is depicted. The example operation is depicted as a process flow 200 and is described herein with respect to FIG. 1. Generally, the process flow 200 enhances path mapping by the navigation system 100 based on safety consideration (for example, based on the fatigue of drivers who are driving on road).

The user of the vehicle 400, for instance, a driver of a man-driving vehicle or a passenger of an autonomous vehicle, may plan to travel from a starting point A to a destination B. Therefore, the user inputs a navigational search or inquiry into the navigation system 100.

The process flow 200 begins at block 205, where a path mapping inquiry to at least one expected destination is obtained by the navigation system 100. For instance, the at least one expected destination can be a recommendation place by the navigation system 100 based on the user's interested place or travel requirements, such as gas stations, scenic spots, restaurants or hotels etc. In some instances, the path mapping inquiry can also include additional purposes besides the expected destination, such as the shortest travel distance or time, the cheapest tolls or ticket fees, the best traffic status or a specific environment (e.g., forest, beach or mountain) etc. In general, the expected destination can be chosen by the user or provided to the user by other sources based on a variety of demands from the user. The path mapping inquiry can be inputted into the navigation system 100 by inputting devices, for instance, an interactive interface device of a handheld device or an in-vehicle navigation device etc. In some instances, the navigation system 100 can obtain the path mapping inquiry from other software applications, such as a third-party navigation application or a business services application, or from a remote data source, such as a website through the internet.

At block 210, the navigation system 100 generates two or more alternative paths to the at least one expected destination. Some factors may be considered into generating the alternative paths. These factors include: the shortest distance from the starting point to destination, the minimal time on traveling from the starting point to the destination, traffic status of the whole path, tolls or expenses, the running speed (which is higher on highways), or the environment on the path etc.

At block 215, the navigation system 100 collects safety parameters from one or more vehicles on the alternative paths, for instance, using detecting devices on the vehicles. Under ideal conditions, it is expected that all of the vehicles on the alternative paths are involved in the collecting step for generating the best result of the enhanced path mapping method disclosed in the present disclosure. However, despite that, collecting the safety parameters from a part of the vehicles on the alternative paths can be sufficient to provide a higher safety than other navigation applications without considering the interactive impact from the vehicles on the alternative paths.

In one or more embodiments of the present disclosure, at least one of the safety parameters can be collected from drivers of the man-driving vehicles and may be a biometric index to indicate a degree of fatigue of the drivers. The biometric data may include heart rate, pulse level, blood pressure level, glucose levels, pupillary size, eye-blink rate, sound level, stress levels, adrenalin level, etc.

In one or more embodiments of the present disclosure, at least one of the safety parameters can be related to operational status collected from the vehicles on the alternative paths and different environments. The operational status of the vehicles may include dynamic information such as vehicle velocities, accelerated velocities, moving directions, turning radiuses, pitch angles, braking or reversing etc. The operational status of the vehicles may also include vehicle conditions, such as vehicle sizes, vehicle weights, vehicle ages, working conditions of engines or braking systems, fuel quantities, passenger quantities, cargo loadings etc. The operational status of the vehicles may also include vehicle position information, such as real-time (GPS) positions, altitude or current driving lanes etc. For obtaining higher safety consideration, more aspects and quantities of data on the operational status of the vehicles are helpful and expected in the present disclosure.

In addition, the physical status of environment is considered by the present disclosure. The physical status of environment may include road conditions (levels) of the alternative paths, such as planeness, compactness, cling property or water permeability etc. The physical status of environment may also include weather conditions, such as raining, snowing, freezing, fogging, storming or day/night etc. The surrounding environments of the alternative paths may also be included into the safety parameters, such as schools, villages, factory districts or public meeting places etc. The traffic status of the alternative paths may also be included into the safety parameters, such as traffic jam, traffic incidents, emergent controlling or unimpeded etc. The additional information on the environment involved in the method of the present disclosure further increases the accuracy of the safety consideration in complex real-life environments.

According to one embodiment, one of the safety parameters is a driving habits index of the drivers on the alternative paths. The driving habits index indicates the driver's driving habits or styles to demonstrate obvious or potentially dangerous driving behaviors, such as overspeed driving, emergency braking, abrupt acceleration, tailgating, changing lanes frequently or illegal parking etc. To generate the driving habits index, different driving behaviors can be tracked and recorded, then the original data is sorted and calculated by a Driving Behavior Questionnaire (DBQ) or Driving Style Questionnaire (DSQ) device/system to generate a driving habits index for safety driving. For instance, the driving habits index can be generated on the basis of the drivers' driving behaviors recorded by an in-vehicle automobile data recorder and a DBQ/DSQ device/system.

According to one embodiment, the vehicles on the alternative paths include at least one autonomous vehicle, and one of the safety parameters is related to an autonomous vehicle safety index of the at least one autonomous vehicle. The autonomous vehicle safety index demonstrates a safety level of one of the autonomous vehicles, in some instances, according to the autonomous vehicles' brands and autonomous driving control algorithms. For instance, government offices or authoritative vehicle safety testing and rating institutes, such as the National Highway Traffic Safety Administration (NHTSA), The European New Car Assessment Programme (EURO NCAP) or The Australasian New Car Assessment Program (ANCAP), have provided safety testing results for new cars including autonomous vehicle safety indexes that can be used in the present disclosure.

At block 220, the navigation system 100 processes the safety parameters to calculate path safety indexes of the alternative paths. The safety parameters are collected using the detecting devices at block 220. Then, the safety parameters are processed by calculators in the navigation system 100. The calculators process the safety parameters according to a preset path safety index algorithm and separately calculates the path safety indexes, for instance, for each of the alternative paths. The processing further comprises steps for calculating the path safety indexes.

According to one embodiment, the processing further comprises splitting each of the alternative paths into different sections.

According to one embodiment, the processing further comprises generating a weighted value for each of the sections and processing the safety parameters according to each of the sections to separately calculate a section safety index for each section.

According to one embodiment, the processing further comprises using a weighting algorithm to calculate the path safety index according to the weighted values and the section safety index value which generated from separately calculating the section safety index for each section.

At block 225, the navigation system 100 determines a superior, or optimal, path between the alternative paths based on the path safety indexes calculated in the step at the block 220. Specifically, for example, the optimal path may be the alternative path with the maximum value in all of the path safety indexes, whereby the maximum value may indicate the path with the least amount of safety concerns. Also, for example, the superior path may be determined according to the path safety index along with other factors. As such, the path safety index may be one of the factors, but the path safety index may be a higher priority or weight coefficient in all of the factors that are considered.

An exemplary embodiment of the method of the present disclosure herein has been illustrated for calculating the path safety index of each of the alternative paths according to the method of the present disclosure in real-world environments.

According to one embodiment, an autonomous vehicle 400′ needs to travel from a starting point A′ to a destination B′. A user or passenger of the autonomous vehicle 400′ inputs a path mapping inquiry into the navigation system 100 for mapping an optimal path between the starting point A′ and the destination B′ based on safety considerations.

The navigation system 100 obtains the path mapping inquiry, then generates two alternative paths S, Y to the destination B′. Some non-safety factors may be considered into generating the alternative paths. These factors include: the shortest distance from the starting point to destination, the minimal time on traveling from the starting point to the destination, traffic status of the whole path, tolls or expenses, the running speed which is higher on highways or the environment on the path etc. In this embodiment, the alternative path S is the path with the shortest distance from the starting point A′ to destination B′, and the alternative path Y is a longer path, however, with cheaper tolls than the alternative path S.

Then, the navigation system 100 collects safety parameters from one or more vehicles on the alternative paths using detecting devices, and the vehicles may include man-driving vehicles and/or autonomous vehicles. If technical conditions are available for each vehicle, all of the vehicles on the alternative paths may be involved in the collecting of safety parameters for gaining the best effect of path mapping. In this embodiment, there are seven man-driving vehicles and one autonomous vehicle on the alternative paths S, and the navigation system 100 may collect the safety parameters for all of the vehicles on the alternative path S using in-vehicle detecting devices or other information sources, such as internet.

In this embodiments, the collected safety parameters may include the following data:

Driver's Fatigue Driving Index p - - - The value of pⱼ is between 0 and 1, and a less value of pⱼ means a higher safety level. This index demonstrates the driver's fatigue level who is driving the vehicle on the alternative path using the corresponding detecting devices, in some instances, an in-vehicle human face video capturing device and application software that can capture and analyze the driver's face images to generate a real-time evaluation value of the driver's fatigue.

Driver's Driving Habits Index q - - - The value of qⱼ is between 0 and 1, and a less value of qⱼ means a higher safety level. This index demonstrates potential dangerous driving behaviors of the driver who is driving the vehicle on the alternative path using the corresponding detecting devices that may include an in-vehicle automobile data recorder and a Driving Behavior Questionnaire (DBQ)/Driving Style Questionnaire (DSQ) device/system as previously described.

Autonomous Vehicle Safety Index r - - - The value of rₖ is between 0 and 1, and a less value of rₖ means a higher safety level. This index demonstrates a safety level of one of the autonomous vehicles on the alternative paths, in some instances, according to the autonomous vehicles' brands and autonomous driving control algorithms. The index can be provided by government offices or authoritative vehicle safety testing and rating institutes.

Environment Safety Index L - - - The less value of L means the higher safety level, for instance, the value of L is between 0 and 3. This index demonstrates a safety level of environments throughout the alternative paths, in some instances, according to road levels, traffic jam levels, weather conditions etc. In this embodiment, factors of Environment Safety Index have been listed in FIG. 2A.

Then, the navigation system 100 processes the safety parameters to separately calculate a path safety index for each of the alternative paths. The processing further comprises splitting each of the alternative paths into different sections.

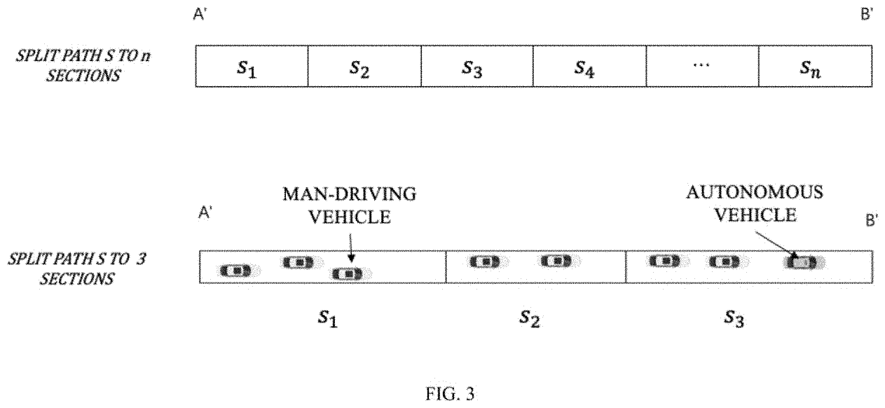

With reference now to FIG. 3, an exemplary operation for splitting an alternative path into different sections is depicted. In FIG. 3, an autonomous vehicle 400′ travels from point A′ to B′. Herein, A′ is a starting point and B′ is a destination. Two alternative paths S, Y are provided by the navigation system 100 based on, for example, the shortest running distance or the cheapest toll. The navigation system 100 splits the path S into three section according to the road levels. For example, the section S1, S3 are minor arterials and S2 is a connector way between S1 and S3. In another instance, the path S may be split into three sections with respect to two crossroads with traffic lights on the path S. In still another instance, the different sections may be chosen based on a specific running length or running time of the autonomous vehicle 400′.

The process for splitting is not limited by the disclosed instances of the present description. Conversely, the discretionary splitting methods are available pursuant to the inquiry of the user of the navigation system 100.

Turning now to FIG. 3, path S is split into three sections S1, S2, S3. In a similar way, path Y is split into four sections Y1, Y2, Y3, Y4. Then, the navigation system 100 processes the safety parameters based on each of the sections to separately calculate a section safety index for each of the sections. The section safety index calculation may be summarized as:

$${s}_{i} = {\sum }_{J = 0}^{m} ( {p}_{j} + {q}_{j} ) + {\sum }_{k = 0}^{g} {r}_{k} + L$$

sᵢ is the section safety index;
m is the quantity of man-driving vehicles in the section;
g is the quantity of autonomous vehicles in the section.

According to FIG. 3, there are three man-driving vehicles in section S1. The sum of Driver's Fatigue Driving Index pⱼ and Driver's Driving Habits Index qⱼ with respect to each of the man-driving vehicles is 0.2, 0.3, 0.5. The autonomous safety index r₁ is 0. The road level of the section S1 is the minor arterial. The weather condition is very good, and the traffic jam level of the section S1 is Jam. Therefore, the environment safety index L is calculated based on the corresponding reference value: L=0.25+0+0.5=0.75. As a result, the section safety index s₁ of the section S1 may be calculated as:

s₁=0.2+0.3+0.5+0+0.75=1.75

In the similar way as the section S1, there are just two man-driving vehicles in the section S2, and the sum of Driver's Fatigue Driving Index pⱼ and Driver's Driving Habits Index qⱼ with respect to each of the man-driving vehicles is 0.2, 04. The autonomous safety index r₂ is 0. The environment safety index L is as same as the section S1. Thereof, the section safety index s₂ of the section S2 may be calculated as:

s₂=0.2+0.4+0+0.75=1.35

There are two man-driving vehicles and an autonomous vehicle in the section S3. The sum of Driver's Fatigue Driving Index pj and Driver's Driving Habits Index qj with respect to each of the man-driving vehicles is 0.1, 0.3. The autonomous safety index r₃ is 0.5. The environment safety index L of the section S3 is 0.25. Therefore, the section safety index s₃ of the section S3 may be calculated as:

s₃=0.1+0.3+0.5+0.25=1.15

Thus, the navigation system 100 may process the safety parameters based on each of the sections to separately calculate the section safety index for each of the sections s₁, s₂, and s₃. Then, the navigation system 100 gives a weighted value to each of the sections based on, for instance, the time tᵢ of the user arriving at an endpoint of the specific section (herein the user is the user or passenger of the autonomous vehicle 400′). The navigation system 100 may estimate the time tᵢ of the user arriving at the endpoint of the specific section using the below formula:

tᵢ=tᵢ₋₁+Sᵢ/vᵢ
Sᵢ is the length of the section;
vᵢ is the average velocity of the vehicles on the section.

According to FIG. 3, the navigation system 100 may estimate the time t₁, t₂, t₃ of the autonomous vehicle 400′ arriving at the endpoints of the section S1, S2, S3, for instance, Sᵢ/vᵢ of the section S1, S2, S3 is preset as 10 min, 15 min, 20 min. Therefore, the result of the time t₁, t₂, t₃ is:

t₁=t₀+S₁/v₁=0+10=10 min

t₂=t₁+S₂/v₂=10+15=25 min

t₃=t₂+S₃/v₃=25+25=50 min
Wherein S₁, S₂, S₃ is the length of the section S1, S2, S3;
v₁, v₂, v₃ is the average velocity of the vehicles on the section.

The weighted value W of the section may be summarized as:

$${w}_{i} = \frac{1 / {t}_{i}}{{\sum }_{j = 1}^{m} ( 1 / {t}_{j} )}$$

the weighted value for the section;
tᵢ is the time of the user arriving at the endpoint of the specific section Si;
m is the quantity of the sections;
tⱼ is the time of the user arriving at the endpoint of the specific section Si.

According to the result of the time t₁, t₂, t₃, the weighted value of each of the sections may be calculated:

w₁=0.625

w₂=0.25

w₃=0.125

As a result, the navigation system 100 may use a weighting algorithm to calculate the path safety index according to the weighted value wᵢ and the section safety index values sᵢ from separately calculating the section safety index for each of the sections. The weighting algorithm may be summarized as:

$$U = {\sum }_{i = 1}^{n} {w}_{i} {s}_{i}$$

n is the quantity of the sections.

In this embodiment, the path safety index U of the path S calculated through the weighting algorithm is summarized as:

U=0.625*1,75+0.25*1.35+0.125*1.15=1.575

The navigation system 100 calculates the path safety index for each of the alternative paths to calculate the path safety index U of the path S. Then, it determines the superior (optimal) path out of all of the alternative paths based on the path safety index. In this embodiment, the superior path is the path with the minimum path safety index, or the path that has the maximum value indicating that it is the path the least amount of safety concerns. According to one embodiment, the superior path is determined based on the specific path safety index in accordance with the different methods of processing the safety parameters to calculate a path safety index for each of the alternative paths.

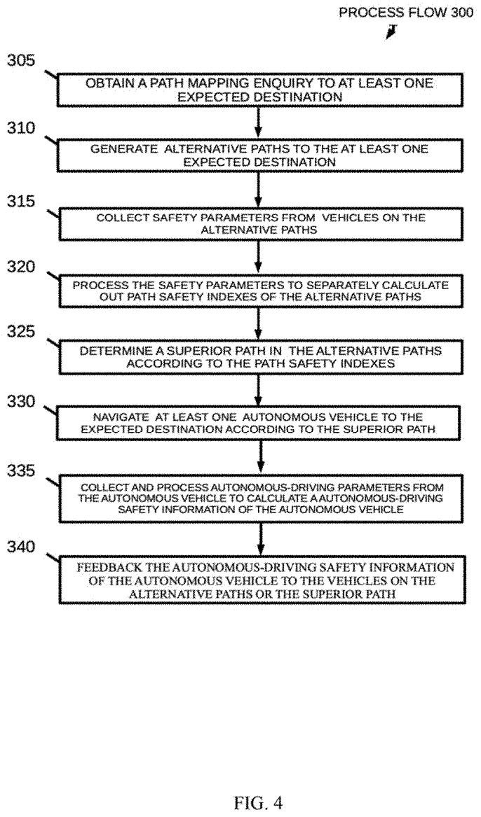

With reference now to FIG. 4, another example operation of the present disclosure according to one exemplary embodiment is depicted in FIG. 4. The example operation is depicted as a process flow 300. The process flow 300 enhances a path mapping by the navigation system 100 based on safety considerations as well as based on the result of the path mapping to auto-pilot the autonomous vehicle 400′.

At block 305, a path mapping inquiry to at least one expected destination is obtained by the navigation system 100.

At block 310, the navigation system 100 generates two or more alternative paths to the at least one expected destination.

At block 315, the navigation system 100 collects safety parameters from one or more vehicles on the alternative paths.

At block 320, the navigation system 100 processes the safety parameters to calculate path safety indexes of the alternative paths.

At block 325, the navigation system 100 determines a superior path in the alternative paths based on the path safety index calculated in the step at the block 320.

At block 330, the navigation system 100 navigates at least one autonomous vehicle to the expected destination according to the superior path. For instance, the user (passenger) of the autonomous vehicle chooses the superior path, and the navigation system 100 navigates the autonomous vehicle 400′ autonomously to the expected destination. The navigation system 100 may be integrated into the autonomous vehicle 400′ as a part of an autonomous driving control system of the autonomous vehicle 400′ so that the user or passenger of the autonomous vehicle 400′ indeed does not need really choose to select the superior path. Conversely, the autonomous driving control system automatically chooses the superior path as preset programs or instructions.

At block 335, the navigation system 100 collects and processes autonomous-driving parameters from the autonomous vehicle to calculate an autonomous-driving safety information of the autonomous vehicle 400′. The autonomous-driving safety information demonstrates the information with respect to aspects of the autonomous vehicle 400′. At least one part of the autonomous-driving safety information includes a dynamic operational status of the autonomous vehicle 400′, such as running velocity, running accelerated velocity, running direction, running lanes etc. In some instances, the autonomous-driving safety information includes the Autonomous Vehicle Safety Index r of the autonomous vehicle 400′.

At block 340, the navigation system 100 uses the autonomous-driving safety information of the autonomous vehicle 400′ to the vehicles on the alternative paths or just on the superior path. The vehicles on the superior path include man-driving vehicles and/or autonomous vehicles.

For providing the autonomous-driving safety information of the autonomous vehicle to the vehicles on the road, including man-driving vehicles and autonomous vehicles, a method is provided by the present disclosure to resolve the problem of interactive impacting between man-driving vehicles and autonomous vehicles in a complex traffic environment where the man-driving vehicles and autonomous vehicles coexist and interactively impact each other. The advantageous effect of the present disclosure is adequately considering the correlation and impact between man-driving vehicles and autonomous vehicles to simultaneously increase the safety of man-driving and autonomous-driving.

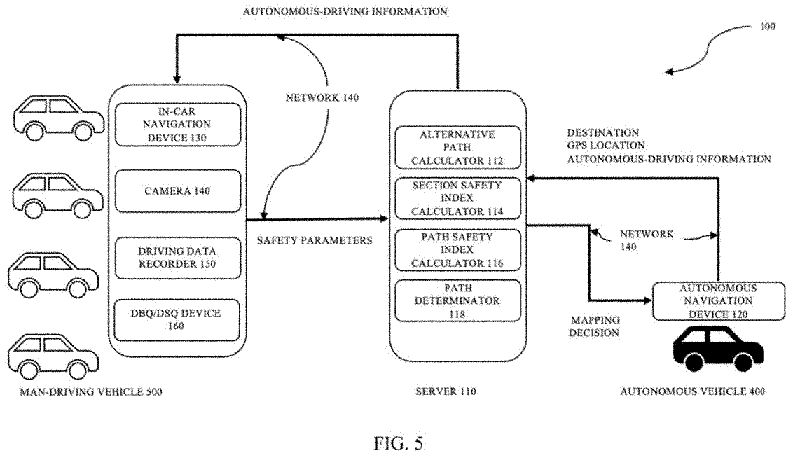

With reference now to FIG. 5, an exemplary embodiment of a navigation system in the present disclosure is depicted in FIG. 5.

FIG. 5 illustrates a navigation system 100, comprising a server 110, an in-vehicle autonomous navigation device 120 on the autonomous vehicle 400, in-vehicle navigation device 130 on a man-driving vehicle 500, and at least one detecting device 140, 150, 160 on the man-driving vehicle 500.

As shown in FIG. 5, the sever 110 for enhanced path mapping based on safety consideration according to an exemplary embodiment of the present disclosure may include an alternative path calculator 112, a section safety index calculator 114, a path safety index calculator 116, a path determinator 118. The navigation device may also include one or more physical connector interfaces whereby power, and optionally data signals, can be transmitted to and received from the device, and may also include one or more wireless transmitters/receivers to allow communication over cellular telecommunications and other signal and data networks.

The alternative path calculator 112 may calculate and generate at least two alternative paths, for instance, from a current position of the autonomous vehicle 400 to a destination. In detail, when the destination is inputted by the user or passenger of the autonomous vehicle 400, the alternative path calculator 112 sets the current position of the vehicle as a starting position and the destination to calculate the alternative paths of the autonomous vehicle.

For each alternative path, the section safety index calculator 114 splits each alternative path into different sections and calculates a section safety index for each section using the safety parameters from one or more vehicles, such as man-driving vehicles 500, on the alternative path using the detecting device 140, 150, 160. The safety parameters may include a biometric index of the man-driving vehicle's driver on the alternative path, an operational status of the vehicles on the alternative path, a physical status of environment, a driving habits index of the driver or an autonomous vehicle safety index of at least one of the autonomous vehicles on the alternative path, etc. For instance, as shown in FIG. 3, the section safety index calculator 114 may split the alternative according to a predetermined distance.

The path safety index calculator 116 calculates a path safety index for each alternative path according to the section safety index and a weighted value of each section. The weighted value of each section may be calculated according to the time of the autonomous vehicle 400 arriving at the endpoint of each section.

The path determinator 118 determines a superior path from the alternative paths according to the path safety index of each alternative path. Thereafter, the autonomous vehicle 400 may be navigated to traveling on the superior path from the starting point to the destination.

The in-vehicle autonomous navigation device 120 is deployed on the autonomous vehicle 400 and provides the navigation service to users or passengers of the autonomous vehicle 400. Generally, the in-vehicle navigation device has at least one processor, a memory, a communication interface, a display or a user input/output interface portion and a positioning or GPS unit. The in-vehicle autonomous navigation device 120 may collect and process autonomous-driving parameters (including GPS location, the destination, the autonomous vehicle safety index etc.) from the autonomous vehicle 400 to calculate autonomous-driving information of the autonomous vehicle and feedback the autonomous-driving information to the sever 110.

The in-vehicle navigation device 130 is deployed on the one or more vehicles on the alternative path, such as man-driving vehicles 500. The in-vehicle navigation device 130 provides the navigation service to the users, such as the drivers of man-driving vehicles 500. In addition, the device 130 may continually monitor some safety parameters including traffic status, driver/user profile, or offer to change the path due to changed conditions. Generally, the in-vehicle navigation device 130 has at least one processor, a memory, a communication interface, a display or a user input/output interface portion and a positioning or GPS unit. The in-vehicle navigation device 130 also transmits the collected safety parameters to the sever 110 using the network 140.

The detecting device 140, 150, 160 are deployed on the man-driving vehicles 500. The detecting device 140, 150, 160 may include: a camera to monitor the driver's face for collecting the biometric index, a driving data recorder (or an On-Board Diagnostics) to monitor the vehicle running status and environment status and a DBQ/DSQ device to track and calculate a driving habits index of the drivers of the man-driving vehicles 500. The detecting devices 140,150, 160 independently work or cooperatively work with the in-vehicle navigation device 130 to collect the safety parameters from the man-driving vehicle 500 to the server 110 through the network 140.

With the alternative path calculator 112, the section safety index calculator 114, the path safety index calculator 116 and the path determinator 118, the sever 110 generates the superior path (the path mapping decision) to the autonomous vehicle 400 and transmit the superior path to the autonomous vehicle 400 using the network 140. For another, the sever 110 may use the autonomous-driving information as feedback to the man-driving vehicles 500 using the network 140.

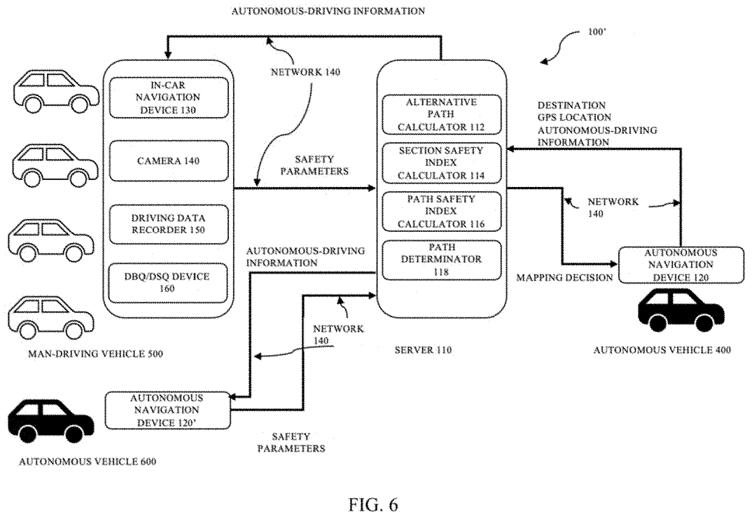

With reference now to FIG. 6, an exemplary embodiment of a navigation system in the present disclosure is depicted. In FIG. 6, the navigation system 100′ comprises a server 110, an in-vehicle autonomous navigation device 120 on the autonomous vehicle 400, an in-vehicle navigation device 130 on a man-driving vehicle 500, an in-vehicle autonomous navigation device 120′ on an autonomous vehicle 600, and at least one detecting device 140, 150, 160 on the man-driving vehicle 500.

According to FIG. 6, the vehicles on the alternative paths still include at least one autonomous vehicle 600 except for the man-driving vehicles 500. An in-vehicle autonomous navigation device 120′ is deployed on the autonomous vehicle 600 and provides the navigation service to users or passengers of the autonomous vehicle 600. The in-vehicle autonomous navigation device 120′ collects some safety parameters with respect to, for instance, the Autonomous Vehicle Safety Index and GPS location from the autonomous vehicle 600 and transmit these safety parameters to the sever 110 using the network 140. Furthermore, the in-vehicle autonomous navigation device 120′ also receives the autonomous-driving information of the autonomous vehicle 400 feedbacked by the sever 110 using the network 140.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

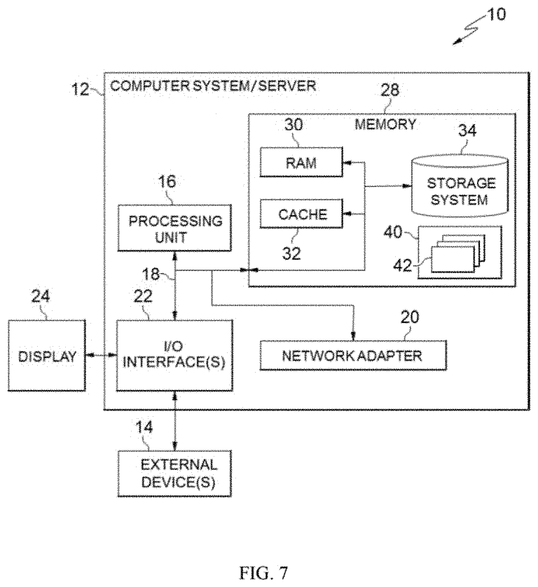

Referring now to FIG. 7, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purposes or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

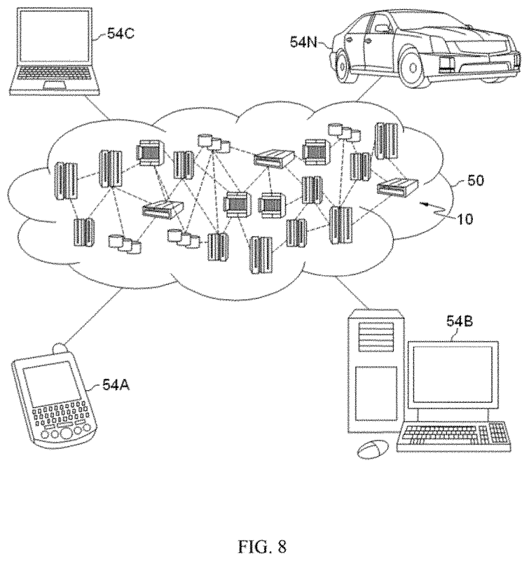

Referring now to FIG. 8, illustrative cloud computing environment 50 is depicted. As shown, cloud computing environment 50 includes one or more cloud computing nodes 10 with which local computing devices used by cloud consumers, such as, for instance, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

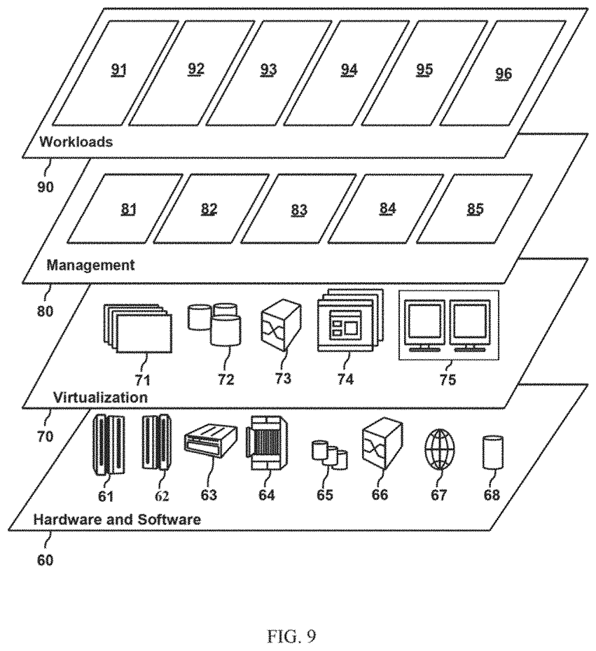

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the disclosure are not limited thereto. As depicted, the following layers and corresponding functions are provided:

Hardware and software layer 60 include hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; the mapping and navigation in the present disclosure 96.

It should be noted that the processing of the method and/or system for enhanced path mapping based on safety consideration according to embodiments of this disclosure could be implemented by computer system/server 12 of FIG. 7.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for instance, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for instance, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for instance, through the Internet using an Internet Service Provider). In some embodiments, electronic circuitry including, for instance, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For instance, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure just have been presented for purposes of illustration, are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for path mapping, the computer-implemented method comprising:
obtaining, by one or more processors, a path mapping inquiry to at least one expected destination;
generating, by one or more processors, two or more alternative paths to the at least one expected destination;
collecting, by one or more processors, safety parameters from one or more vehicles on the two or more alternative paths;
processing, by one or more processors, the safety parameters to calculate path safety indexes of the two or more alternative paths; and
determining and selecting, by one or more processors, a path between the two or more alternative paths based on the path safety indexes.

2. The computer-implemented method of claim 1, further comprising:
navigating, by one or more processors, at least one autonomous vehicle to the at least one expected destination according to the selected path.

3. The computer-implemented method of claim 2, further comprising:
collecting and processing, by one or more processors, autonomous-driving parameters from the at least one autonomous vehicle to calculate autonomous-driving safety information of the autonomous vehicle.

4. The computer-implemented method of claim 3, further comprising:
providing, by one or more processors, the autonomous-driving safety information of the autonomous vehicle to the one or more vehicles.

5. The computer-implemented method of claim 1, wherein at least one of the safety parameters is related to a biometric index of at least one of drivers of the vehicles to indicate fatigue degrees of the drivers.

6. The computer-implemented method of claim 1, wherein the safety parameters is selected from a group comprising an operational status of the one or more vehicles and a status of an environment.

7. The computer-implemented method of claim 1, wherein one of the safety parameters is related to a driving habits index of at least one of driver of a vehicle.

8. The computer-implemented method of claim 1, wherein the one or more vehicles include at least one autonomous vehicle, and one of the safety parameters is related to an autonomous vehicle safety index of the at least one autonomous vehicle.

9. The computer-implemented method of claim 1, wherein processing the safety parameters to calculate the path safety indexes of the alternative paths further comprises:
splitting each of the alternative paths into a plurality of sections.

10. The computer-implemented method of claim 9, wherein processing the safety parameters to calculate the path safety indexes of the alternative paths further comprises:
processing the safety parameters of each of the sections associated with the plurality of sections to calculate a section safety index for each of the sections.

11. The computer-implemented method of claim 10, wherein processing the safety parameters to calculate the path safety indexes of the alternative paths further comprises:
generating a weighted value for each of the sections; and
using a weighting algorithm to calculate the path safety indexes according to the weighted value and the section safety index.

12. A computer system for path mapping, the system comprising:
one or more processors, one or more computer-readable memories, one or more computer-readable tangible storage devices, and program instructions stored on at least one of the one or more computer-readable tangible storage devices for execution by at least one of the one or more processors via at least one of the one or more computer-readable memories, wherein the computer system is capable of performing a method comprising:
obtaining a path mapping inquiry to at least one expected destination;
generating one or more alternative paths to the at least one expected destination;
collecting safety parameters from one or more vehicles on the one or more alternative paths;
processing the safety parameters to calculate a path safety index of the one or more alternative paths; and
determining and selecting a path between the one or more alternative paths according to the path safety indexes.

13. The computer system of claim 12, further comprising:
navigating at least one autonomous vehicle to the expected destination according to the selected path.

14. The computer system of claim 12, further comprising:
collecting and processing autonomous-driving parameters from the autonomous vehicle to calculate autonomous-driving information of the autonomous vehicle.

15. The computer system of claim 12, further comprising:
providing the autonomous-driving safety information of the autonomous vehicle to the one or more vehicles.

16. The computer system of claim 12, wherein at least one of the safety parameters is related to a biometric index of at least one of driver of a vehicle to indicate a degree of fatigue degrees of the at least one driver.

17. A computer program product for path mapping, comprising:
one or more tangible computer-readable storage devices and program instructions stored on at least one of the one or more tangible computer-readable storage devices, the program instructions executable by a processor, the program instructions comprising:
program instructions to obtain a path mapping inquiry to at least one expected destination;
program instructions to generate one or more alternative paths to the at least one expected destination;
program instructions to collect safety parameters from one or more vehicles on the one or more alternative paths;
program instructions to process the safety parameters to calculate path safety indexes of the one or more alternative paths; and
program instructions to determine and select a path between the one or more alternative paths according to the path safety indexes.

18. The computer program product of claim 17, further comprising:
program instructions to navigate at least one autonomous vehicle to the expected destination according to the selected path.

19. The computer program product of claim 18, further comprising:
program instructions to collect and process autonomous-driving parameters from the autonomous vehicle to calculate autonomous-driving safety information of the autonomous vehicle.

20. The computer program product of claim 19, further comprising:
program instructions to provide the autonomous-driving safety information of the autonomous vehicle to the one or more vehicles.
